(19) United States
(12) Patent Application Publication
(10) Pub. No.: US 2007/0041031 A1
(43) Pub. Date: Feb. 22, 2007

(54) Print management method, recording medium storing a program, and print management apparatus

(75) Inventor: Kotaro Kaneko, Tokyo (JP)

Correspondence Address: FINNEGAN, HENDERSON, FARABOW, GARRETT & DUNNER;LLP, 901 NEW YORK AVENUE, NW, WASHINGTON, DC, 20001-4413, US

(73) Assignee: KONICA MINOLTA BUSINESS TECHNOLOGIES, INC.

(21) Appl. No.: 11/295,532

(22) Filed: Dec. 7, 2005

(30) Foreign Application Priority Data
Aug. 18, 2005 (JP) 2005-237375

(51) Int. Cl. G06K 15/00

(52) U.S. Cl. 358/1.14; 358/1.15

(57) ABSTRACT

Disclosed is a print managing method including: managing a plurality of files created by at least one application program as one print unit; setting usage restriction information to the print unit; and restricting a user usage of each file contained in the print unit according to the usage restriction information.

### BACKGROUND OF THE INVENTION

1. Field of the Invention

The present invention relates to a print management method, a recording medium storing a print management program, and print management apparatus.

2. Description of Related Art

Currently, various kinds of application programs (hereinafter abbreviated as “application” accordingly) such as software for word-processing, software for spreadsheet, software for image editing, software for presentation, and the like are disseminated. Each of a document, a graph, and the like, created or edited by corresponding one of these applications, is stored in a file in a data form on an application basis. For example, when printing document and graph for a conference material use, each of the files is printed by a printer (printing apparatus), by initiating individually the software for word-processing and the software for spreadsheet, opening the file corresponding to each application, and then performing print instruction individually.

Further, as a method to perform printing of a plurality of files in an organized manner, in case of printing a plurality of files created by different application, to store an attribute data of the plurality of files (document data) in an object called “binder”, and then to perform print output of the plurality of files in an organized manner according to the attribute data of the binder is known in the conventional techniques. (JP-2001-84246A, hereinafter referred to as “patent reference 1”)

Meanwhile, in case printing is performed in an organized manner by taking the plurality of files as one unit, ways of using a file may be different among users, such as a user who edits the plurality of files, a user who performs print execution, and the like. In this case, it is necessary to apply a usage restriction to the file under creation to prevent edition or printing or the like by a user other than the person in charge.

However, since a management method that utilizes the technique of the patent reference 1 is merely a method to store the attribute data for each file, it is possible that the file under management will be edited by the user other than the person in charge, not via the binder. Additionally, in a case where an access is made directly to the binder, it is possible that fraud printing is performed by the user other than the person in charge. Therefore, within the technique of patent reference 1, a security problem regarding alteration and leakage and the like of the file has arisen.

### SUMMARY

The present invention has been made to solve the above problem. An object of the invention is to improve security of a plurality of files created by application program.

In order to solve the above problems, according to an embodiment reflecting one aspect of the invention,

a plurality of files created by at least one application program is managed as one printing unit;

usage restriction information is set for the printing unit; and

a user usage of each file included in the printing unit is restricted according to the usage restriction information.

Preferably, the usage restriction information includes an editing advisability of the files included in the printing unit.

Preferably, the usage restriction information includes a printing advisability of the files included in the printing unit.

Preferably, the usage restriction information includes a changing advisability of print setting information of the file included in the printing unit.

Preferably, the usage restriction information includes a changing advisability of print order of the file included in the printing unit.

Preferably, the usage restriction information for the printing unit is set for each user.

### BRIEF DESCRIPTION OF THE DRAWINGS

The present invention will become more fully understood from the detailed description given hereinafter and the accompanying drawings which are given by way of illustration only, and thus are not intended as a definition of the limits of the scope of the invention, and wherein:

FIGS. 1A and 1B are block diagrams showing an embodiment of a system structure of a print management system and a function structure of each apparatus;

FIG. 2A is a view showing an example of a data structure of an entire setting data;

FIG. 2B is a view showing an example of a data structure of individual print setting data;

FIG. 3 is a view showing an example of a data structure of a user management data;

FIG. 4 is a first flow chart to explain specific processing steps within organized print processing;

FIGS. 5A and 5B are second flow charts to explain specific processing steps within print processing;

FIG. 6 is a flow chart to explain specific processing steps within print processing;

FIG. 7A is a view showing an example of a display of a log in screen;

FIG. 7B is a view showing an example of a display of an organized printing listing screen;

FIG. 8A is a view showing an example of a display of file selecting screen;

FIG. 8B is a view showing an example of a display of file listing screen;

FIG. 9A is a view showing an example of a display of a detail setting screen;

FIG. 9B is a view showing an example of a display of a screen for a manager;

FIG. 10A is a view showing an example of a display of an organized printing listing screen;

FIG. 10B is a view showing an example of a display of a detail setting screen;

FIG. 11 is a view showing an example of execution result of the organized printing; and

FIG. 12 is a view showing an example of data structure of the entire setting data within an example of modification.

### DETAILED DESCRIPTION OF THE PREFERRED EMBODIMENTS

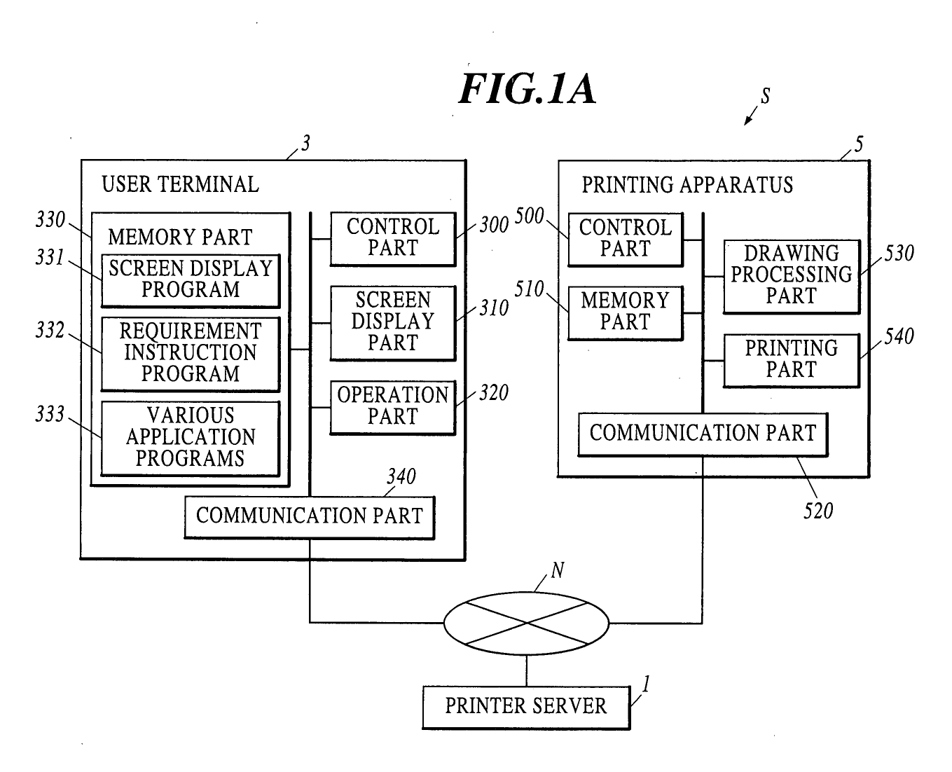

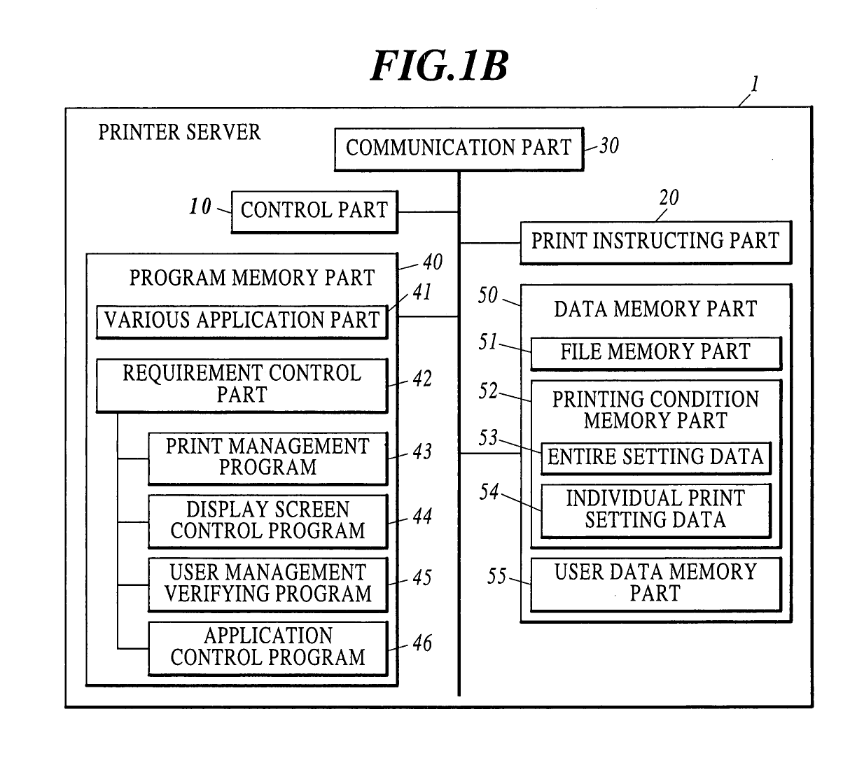

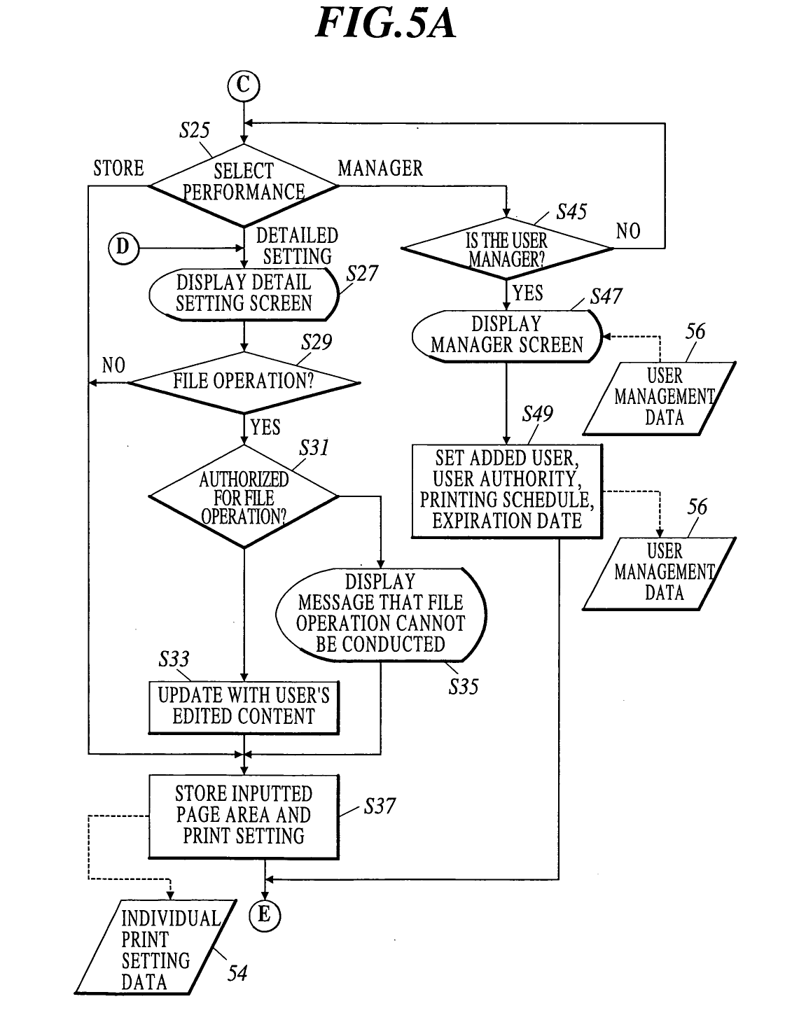

An embodiment of a print management system provided with a printer sever, wherein a print management apparatus of the present invention is applied to the printer server, will be described below with reference to FIGS. 1 to 12.

First of all, a system structure of a print management system S will be explained. As shown in FIGS. 1A and 1B, the print management system S comprises a printer server 1, a user terminal 3, a printing apparatus 5 such as copying machine, facsimile, printer, composite machine functionally combined with the mentioned devices, and the like. These are structured connectively through a communication circuit N such as LAN, public circuit web and the like, and are capable to exchange data.

A user initiates various kinds of applications at the user terminal 3, creates a file of document, graph, or the like, and performs print instruction of the file. The file that was subjected to print instruction at the user terminal 3 is sent to printing apparatus 5 through printer server 1, and a print output is performed.

Printer server 1 manages a file created at the user terminal 3. As for a function of this file management, there is an “organized printing” function that can set page for print output, print settings, or the like for each files individually, and then perform print output of a plurality of files at one time. With this organized printing, in case of performing print output of a plurality of files created by various kinds of applications in an organized manner, printing only necessary page among the files, and further changing individually, size of paper for that page, duplex printing, stapling, and the like, can be achieved.

As for a function to manage file, there is a “scheduled printing” function that starts printing on a predetermined date and time. Settings regarding these organized printing and scheduled printing can be set only by the predetermined manager. Additionally, editing a file subject to organized printing and starting instruction for organized printing can be done only by a user authorized by the manager.

Next, a function structure of each apparatus structuring the print management system S will be explained with reference to FIGS. 1A and 1B. The user terminal 3 comprises a control part 300, a screen display part 310, an operation part 320, a memory part 330, and a communication part 340.

The control part 300 comprises CPU (Central Processing Unit), ROM (Read Only Memory), RAM (Random Access Memory), and the like. The control part 300 is a functional part which executes processing according to the predetermined program based on an instruction inputted, gives instruction to various kinds of function parts, inputs and outputs data, thus controls the user terminal 3 comprehensively. Particularly, the CPU reads a program installed in the ROM and memory part 330 and the like upon power-on or based on operation signal inputted from operation part 320, and displays result of a processing corresponding to the program, on the screen display part 310.

The screen display part 310 is comprised of CRT (Cathode-ray Tube), LCD (Liquid Crystal Display), or the like, and outputs display for various kinds of screens according to display data inputted from control part 300. Operation part 320 is provided a keyboard with a cursor key, a numeric keypad, or other various kinds of functional keys, a pointing device such as a mouse or the like. The operation part 320 outputs operation signals, such as depression signal of a key depressed and position signal of mouse, to the control part 300. The communication part 340 is a function part to exchange data by connecting to communication circuit N, and is provided with modem, LAN interface, USB, and the like.

The memory part 330 is a function part to read and write data in a memory medium such as CD-ROM, memory card, hard disk, and the like. The memory medium is structured with magnetic or optic memory medium or a semiconductor memory, and stores data and the like, processed by application program and various kinds of processing programs.

According to FIGS. 1A and 1B, memory part 330 stores a screen display program 331, a requirement instruction program 332, and various kinds of application programs 333 such as word-processing software, spreadsheet software, image editing software, and the like. The screen display program 331 is a program to control displaying various kinds of screens such as a file selecting screen 420, a detail setting screen 440 and the like on a screen display part 310. The requirement instruction program 332 is a program to receive requirement instruction of the user from the operation signal of the operation part 320, or receive requirement instruction from the printer server 1. The control part 300, corresponding with the requirement instruction program 332 and screen display program 331, displays display screen based on the operation of the operation part 320 by the user, and displays display screen according to a display data sent from the printer server 1.

Additionally, the control part 300 initiates application program 333 corresponding to the user's operation, and creates document file, graph file, and the like. At this time, an extension based on the application is added to a file name of each file, and application program 333 for creating the file can be identified according to the extension. For example, when the extension is “aaa”, it is a document file created by word processing software, when the extension is “bbb”, it is a graph file created by spreadsheet software. The control part 300 sends the created or edited file to the printer server 1, and stores it in a data memory part 50 of the printer server 1.

A printing apparatus 5 is provided a control part 500, a memory part 510, a drawing processing part 530, a printing part 540, and a communication part 520. The control part 500 is a function part comprising CPU, ROM, RAM and the like, and executes processing according to the predetermined program, gives instruction to various kinds of function parts, inputs and outputs data, thus controls the user terminal 3 comprehensively.

The memory part 510 is a function part to read and write data in a memory medium such as VRAM (Video RAM), memory card, hard disk, and the like. The memory medium is structured with magnetic or optic memory medium, or a semiconductor memory, and stores file and the like sent from the printer server 1.

The drawing processing part 530 is structured with CPU, DSP (Digital Signal Processor), and the like, and converts the file stored in the memory part 510 into an image data in a data form specific to the printing apparatus 5, performs various kinds of image processing, and then sends it to the printing part 540, according to the instruction from the control part 500.

The printing part 540 is a function part to form an image on a transfer paper. The printing part 540 expose scans a photosensitive drum by a laser beam radiated from an exposing part, and forms an electrostatic latent image according to an image data outputted from the drawing processing part 530. Subsequently, a developing material is adhered on the photosensitive drum at developing part, transferred to a transfer paper, and then toner is heat fused on the transfer paper at a fusing part, thus forming an image. The communication part 520 is a function part to exchange data by connecting to communication circuit N, and is structured provided with modem, LAN interface, USB, and the like.

The printer server 1 is structured provided with a control part lo, a print instructing part 20, a program memory part 40, a data memory part 50, and a communication part 30.

The control part 10 is a function part comprising CPU, ROM, RAM and the like, and executes processing according to the predetermined program, gives instruction to various kinds of function parts, inputs and outputs data, thus controls the printer server 1 comprehensively.

The print instructing part 20 is a function part to control communication with the printing apparatus 5, wherein the control part 10 initiates an application program 41 and performs instruction to the printing apparatus 5, to perform print execution of the file read from file memory part 51.

The communication part 30 is a function part to exchange data by connecting to communication circuit N, and is structured provided with modem, LAN interface, USB, and the like.

The program memory part 40 is structured with nonvolatile memory capable to read and write, such as ROM and the like, and stores program necessary to perform the printer server 1, data related to execute such program, and the like. In FIGS. 1A and 1B, the program memory part 40 stores various kinds of application programs 41 and a requirement control program 42.

The various kinds of application programs 41 are programs equivalent to various kinds of application programs 333 stored at the user terminal 3, such as word-processing software, spreadsheet software, image editing software, and the like.

The requirement control program 42 is a program to achieve request control function that performs each task processing by reading a subroutine based on the requirement from the user terminal 3. The subroutine of the requirement control program 42 comprises a print management program 43, a display screen control program 44, a user management verifying program 45, and an application control program 46.

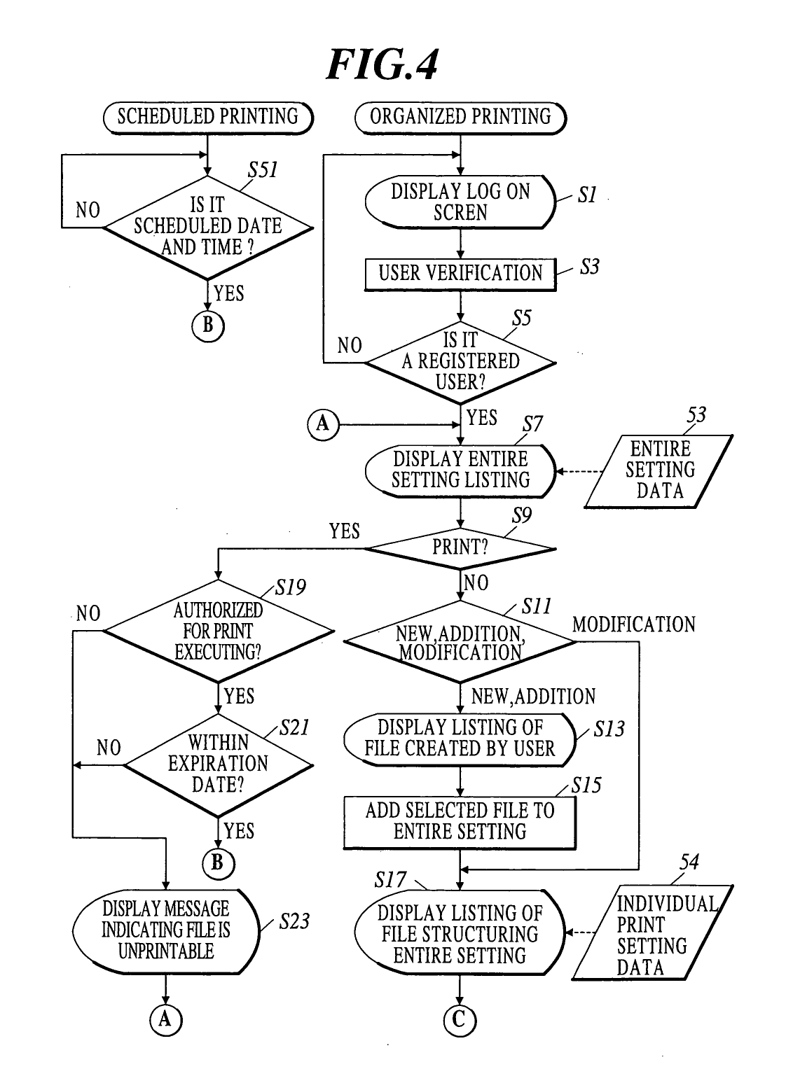

The print management program 43 is a program to achieve print management function that stores various kinds of files that were sent from the user terminal 3, in a file memory part 51, manages print settings and the like for each file, instructs printing, and the like. The screen display control program 44 is a program to control the screen to be displayed on a screen display part 310 of the user terminal 3. The user management verifying program 45 is a program to manage or verify an access authority of the user. The application control program 46 is a program to automatically control application corresponding to various kinds of files created by user terminal 3. Within the association of these subroutines, processing shown in FIGS. 4-6 is achieved.

The data memory part 50 is a function part to read or write data in the memory medium such as memory card, hard disk, and the like. In FIGS. 1A and 1B, the data memory part 50 is structured provided with a file memory part 51, a printing condition memory part 52, a user management data memory part 55, and an inputted user ID memory part 57.

The file memory part 51 is a data area to store various kinds of file bodies created by application of user terminal 3, and copy of a file added by the user in organized printing. The control part 10, in case of organized printing, updates the copied file corresponding to an editing operation by the user, and reflects an edition to the copied file when update button 447 is clicked.

The printing condition memory part 52 is a data area to store printing condition for organized printing, and stores an entire setting data 53 and an individual print setting data 54.

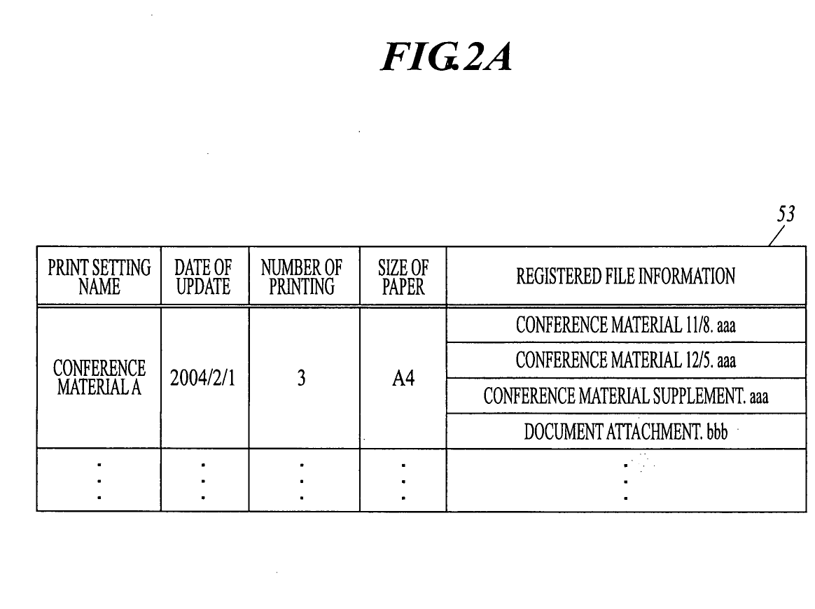

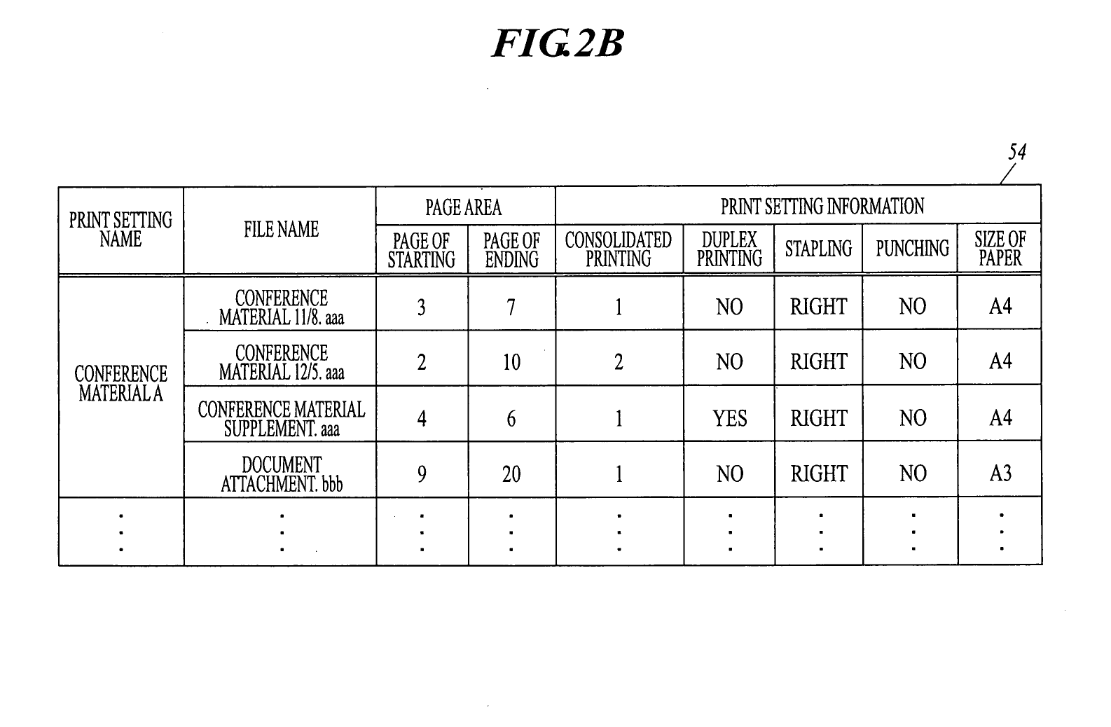

The entire setting data 53 is a data table to manage a plurality of files as one print unit in case of organized printing, and stores print setting name, date of update, number of printing, size of paper, and registered file name in association as shown in FIG. 2A of an example of data structure. The print setting name is a name for identification, named for the entire plurality of files added or selected by the user in case of organized printing, and is inputted by the user. The date of update is a date when number of printing, registered file information, or the like corresponding to the print setting name has been updated, and is set by the control part 10. The registered file name is a file name of an added file in case of organized printing.

The control part 10 stores, regarding the print setting name inputted by the user in organized printing, a file name of an added file in association with the registered file name. For example, in data structure of FIG. 2A, four files, “conference material 11/8.aaa”, “conference material 12/5.aaa”, “conference material supplement.aaa”, and “accompanying material.bbb” are added to the print setting name “material for conference A”, and the entire added file is to be performed print output in A4 sized paper in triplicate.

The individual print setting data 54 is a data table to manage each file added in case of organized printing, and to store print setting name, registered file name, page area including pages for starting and ending, and print setting information in association. The print setting information is setting information to perform print output of a file associated with a registered file name, and includes the number of pages for combination printing in which a plurality of pages of original are printed on one transfer paper, duplex printing, presence of request for stapling or punching, and the size of paper. The size of paper in individual print setting data 54 is the same as the paper size in the entire setting data 53 by default, and can be changed for each file individually by the user.

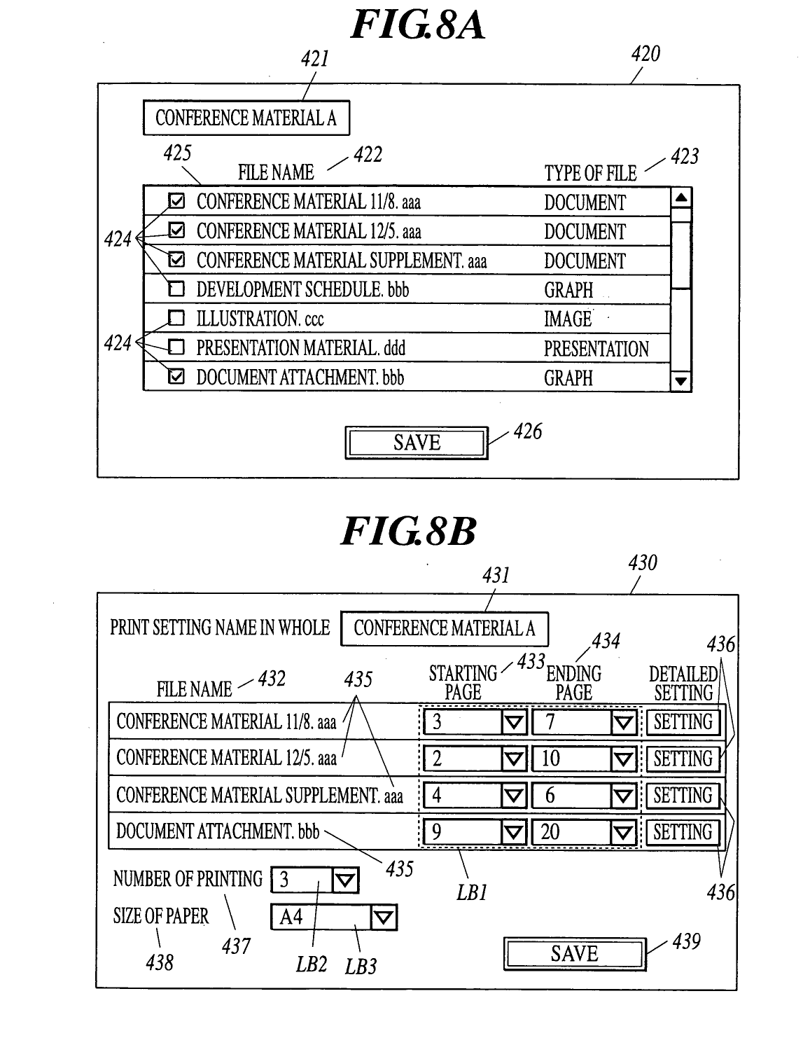

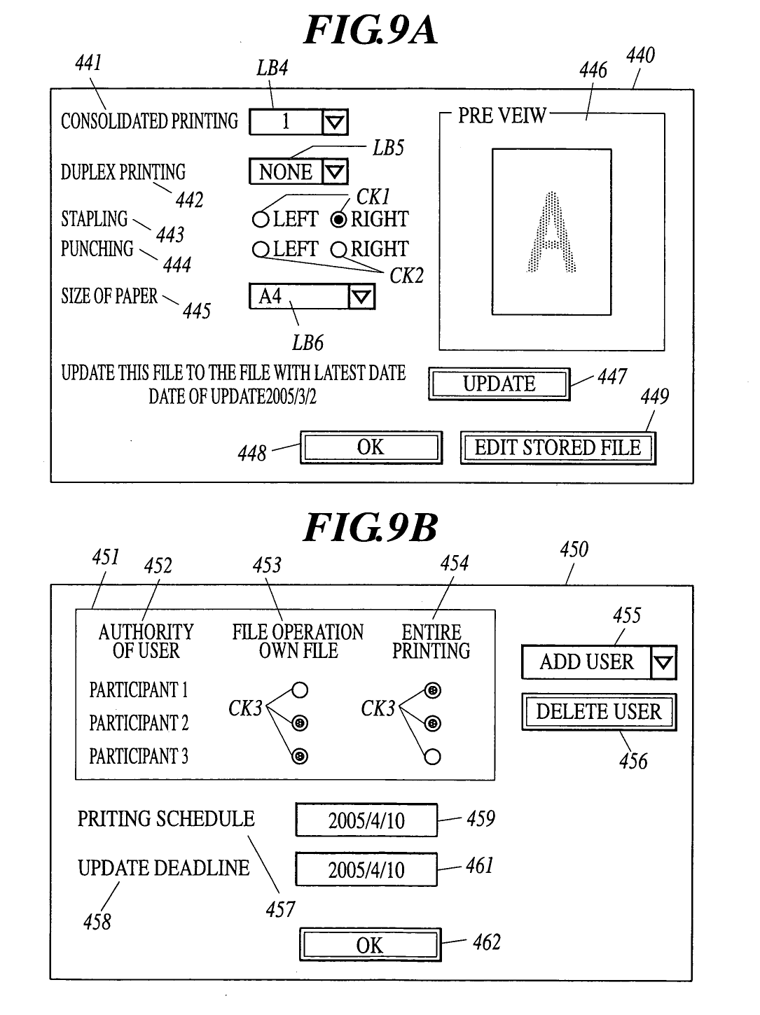

The control part 10 manages printing condition of a plurality of files by creating and adding page area and print setting information, in association with print setting name and registered file name, each time a file is added for organized printing. Additionally, in case change operation to change page area or print setting information is done by the user using a list box and a check box of a file listing screen 430 shown in FIG. 8B and a detail setting screen shown in FIG. 9A, page area or print setting information of individual print setting table 54 is changed and updated based on the change operation. In FIG. 2B, for example, registered file name “conference material 12/5.aaa” is to be performed print output from page 2 to page 10, and 2 pages are to be consolidated on one transfer paper.

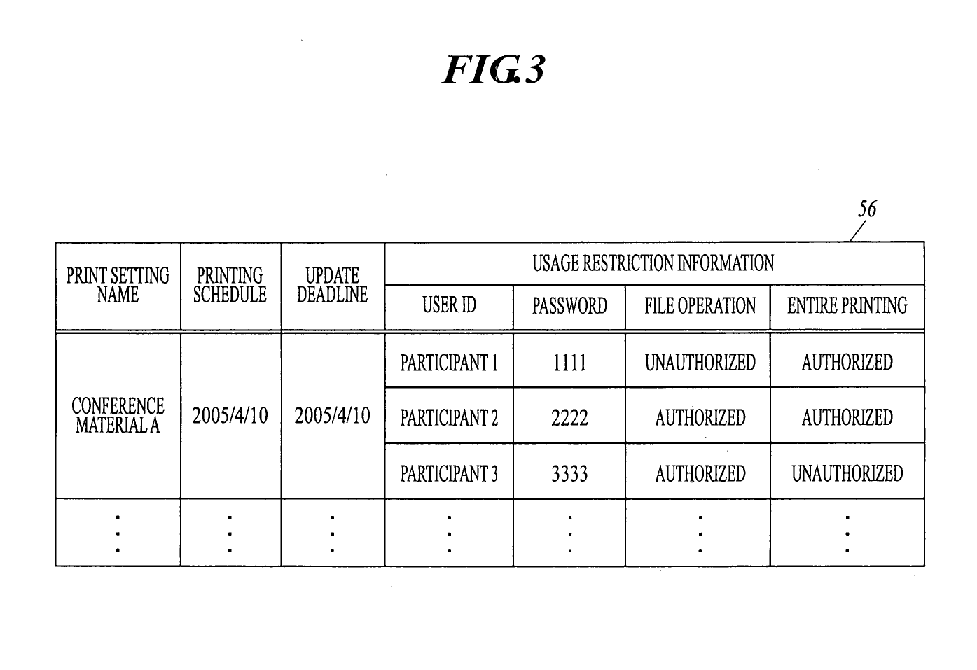

User management data memory part 55 is a data area to store usage restriction information for each user in case of organized printing or scheduled printing, and stores user management data 56 as shown in data structure example in FIG. 3. The user management data 56 is a data table to store print setting name, print schedule, update deadline, and usage restriction information in association.

The print schedule is a time and date to perform scheduled printing, and the update deadline is a deadline up to when it is possible to update settings for organized printing. The usage restriction information is structured provided with a password for each user name, an availability on editing operation of the file (file manipulation) that was additionally registered to the print setting name within the entire setting data 53, and an availability on executing the organized printing (entire printing) of the file added to the print setting name. These can be set only by the user data manager.

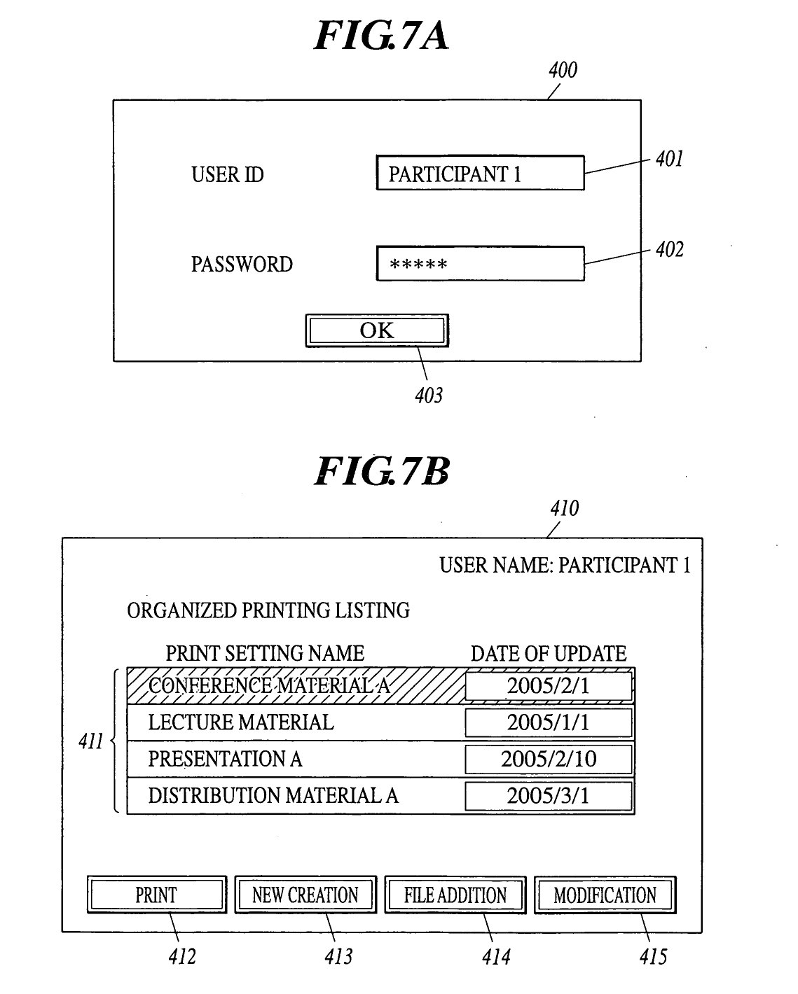

The control part verifies user ID and password inputted from a log on screen 400 as shown in FIG. 7A with the data stored in the user management data memory part 55, then determines whether the user of the user ID can edit a file that was added for organized printing, and whether the user of the user ID can execute organized printing.

Thus, restriction to file editing operation can be applied according to the availability on editing the file included in the usage restriction information, and restriction to the user's print execution of the file can be applied according to the availability on file printing included in the usage restriction information. In addition, restriction for user usage can be applied individually to the user in order to set the usage restriction information for each user.

Inputted user ID memory part 57 is a data area to store user ID inputted in the log on screen 400 as shown in FIG. 7A as a inputted user ID.

Here, the entire setting data 53, the individual print setting data 54, and the user management data 56 can adopt appropriate conventional technology. The technology shall have a data structure that can, by using print setting name, file name, or the like as a search key, search and update corresponding various kinds of information, for example, chart form (table form) shown in FIGS. 2 and 3, layered system, data base structure in XML form, or the like. Additionally, storage location (file pass, for example) in file memory part 51 can be stored as a file name.

Next, specific performance at the printer sever 1 is described with reference to examples of display screen shown in FIGS. 7 to 10, and flow charts shown in FIGS. 4 to 6.

First of all, control part 10 of printer server 1, upon power-on, initiates processing for scheduled printing, monitors present time and date, and remains stand by until the present time and date meets the time and date for the scheduled printing stored in the user management data 56. When the present time and date meets the printing schedule (step S51; Yes), it moves on to step S43 and performs print processing (described later) for print setting name corresponding to the printing schedule as a printing subject.

Meanwhile, when control part 10 detects a requirement of starting instruction for organized printing from the user terminal 3 through a communication part 30, it initiates a processing to control organized printing and displays a log on screen 400 as shown in FIG. 7A on the user terminal 3 (step S1). When the user inputs user ID and password into ID area 401 and password area 402 respectively, and then clicks OK button 403 by a mouse, user verification is requested from a control part 300 of the user terminal 3 to the printer server 1. When control part 10 of the printer server 1 detects requirement from the user terminal 3, it stores the user ID inputted from the ID area 401 into the inputted user ID memory part 57, and performs verification according to the user management data 56. Particularly, a password associated with the inputted user ID is read from the user management data memory part 55, and the password is determined whether it is identical to the password inputted in the password area 402 (step s3).

Subsequently, if it is determined that the inputted password is identical, and the user of the inputted user ID is verified as a user who is already registered in the user management data 56 (step S5; Yes), entire setting data 53 is read from printing condition memory part 52 and organized printing listing screen 410 (shown in FIG. 7B), including print setting name and date of update in the data as a listing list 411, is displayed on the user terminal 3 (step S7). The print setting name in this listing list 411 is selectable by operation from user's operation part 320, and the selected print setting name is displayed in a reverse form as shown in FIG. 7B.

When the control part 10 detects that file addition button 414 has been clicked (step S11; Addition), file selecting screen 420 as shown in FIG. 8A is displayed according to various kinds of files and entire setting data 53 stored in file memory part 51 (step S13).

In particular, file stored in file memory part 51, that is, file listing 425 including file name 422 of a file created by the user at the user terminal 3, type of file 423 determined from extension included in the file, and check box 424 is displayed. Then the registered file name corresponding to the print setting name selected in the organized printing listing screen 410 is read from the entire setting data 53, and the check box of the file name.

Additionally, when it is detected that new creation button 413 has been clicked in step S11 (step S11; New), the control part 10 displays file selecting screen 420 with print setting name area 421 and check box 424 cleared (step S13). Then, after processing step S13, file selection of the user is received from the file selecting screen 420 (step S15).

When control part 10 detects that modification button 415 has been clicked in step S11 (step S11; Edit), or when processing of step S13 has completed, control part 10 reads the registered file name and the page area corresponding to the print setting name selected at organized printing listing screen 410, from the individual print setting data 54, and displays a file listing screen 430 shown in FIG. 8B on the user terminal 3 (step S17). The user can change starting page 433, ending page 434, number of printing 437, and size of paper 438 by operating list boxes LB1, LB2, LB3 on the file listing screen 430.

Accordingly, the control part 10 selects the performance based on a button clicked in the file listing screen 430 (step S25). In particular, when the control part 10 detects that manager button 460 has been clicked (step S25; Manager), in case the user of the inputted user ID is the manager (step S45; Yes), the control unit 10 reads the user management data 56, and displays a manager screen 450 as shown in FIG. 9B on the user terminal 3, according to the data (step S47).

The manager sets an availability (authority) on file operation 453 and entire printing 454 individually for each user, by turning ON or OFF checkboxes CK3 and CK4 in user authority setting area 451 of the manager screen 450. The manager newly adds a user from a user listing displayed by clicking a user addition box 455, and deletes a user displayed in the user authority setting area 451 by clicking a user delete button 456. The manager also sets printing schedule and update deadline by inputting year, month, and date in a schedule area 457 and update deadline area 458.

The control part 10 stores and updates in the user management data 56, an added user, a user authority, printing schedule, and an expiration date set in the manager screen 450 (step S49), and then moves on to processing of step S39.

In step S25, when it is detected that a detail setting button 436 has been clicked, print setting information associated with a file name corresponding to the button is read from the individual print setting data 54, and a detail setting screen 440 as shown in FIG. 9A is displayed (step S27). At this time, a print image when printed according to the print setting information stored in the individual print setting data 54 is displayed in a pre-view area 446.

The user can change consolidated printing 441, duplex printing 442, and size of paper 445 by operating list boxes LB4, LB5, and LB6. Additionally, the user can change presence of request for stapling 443 and punching 444 by operating checkboxes CK1 and CK2.

When it is detected that edit button 449 in detail setting screen 440 has been clicked (step S29; Yes), it is determined whether the user has an authority for file operation within the selected print setting name. The control part 10 refers to the user management data 56, and in case availability of file operation corresponding to the inputted user ID is “authorized”, it is determined that the user has the authority of file operation (step S31; Yes). Subsequently, the application program 41 of file creation is determined according to extension included in the registered file name, and the file is read from the application program 41, and is displayed on the user terminal 3, ready for edition by the user. Additionally, when it is detected that update button 447 has been clicked, the aforementioned file which is the origin of replication is updated with edited content (step S33).

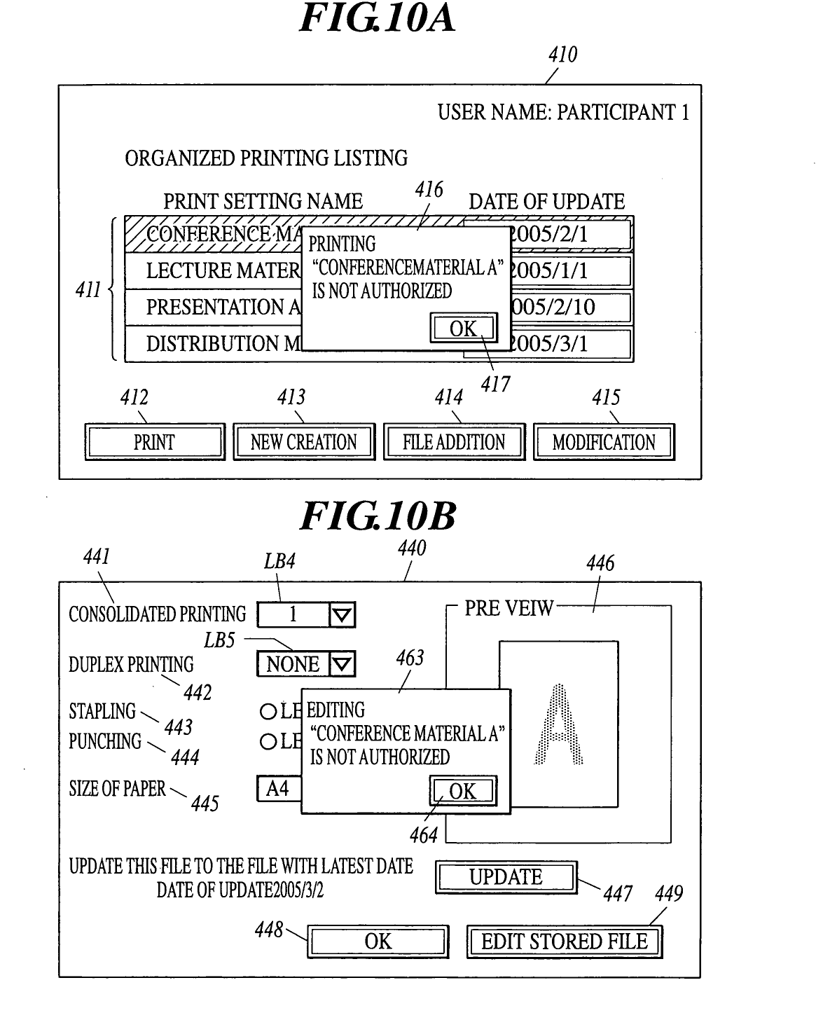

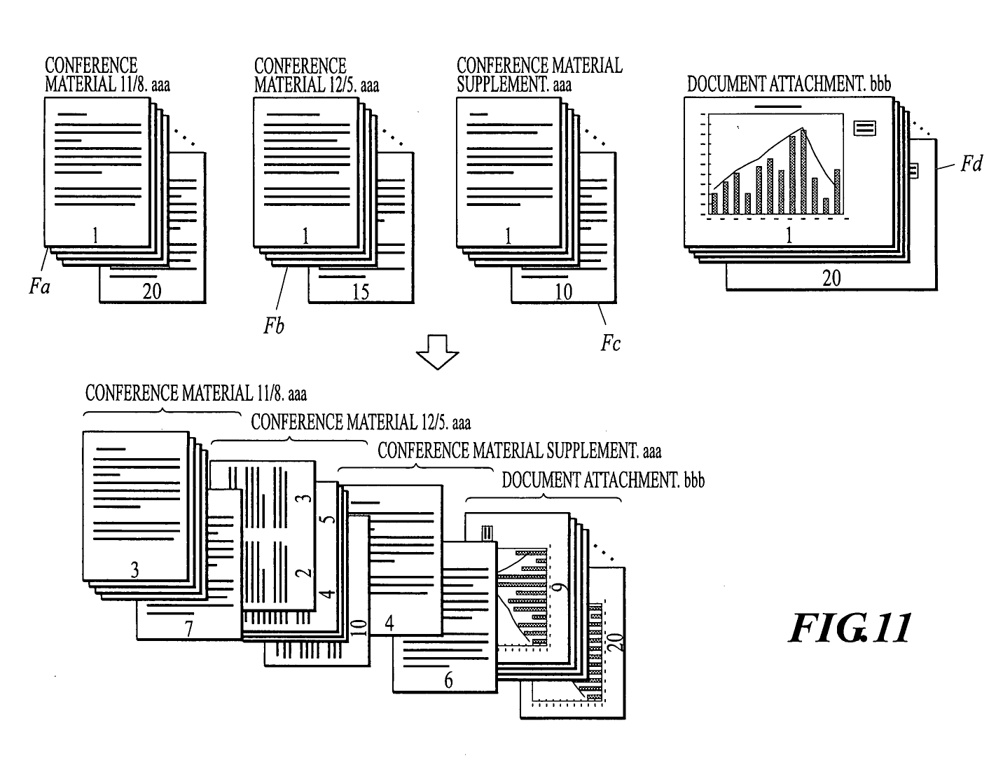

On the contrary, in case availability of file operation corresponding to the inputted user ID is “unauthorized”, it is determined that the user does not have the authority of file operation (step S31; No), and a message indicating that the file within the selected print setting name cannot be edited is displayed in a window 463 as shown in FIG. 10B (step S35). In this way, edit operation of a file is allowed only to the user who has been authorized for file operation beforehand by the manager, and usage of edit operation is restricted to unauthorized user. Therefore, fraud edition by a user other than the person in charge of the file additionally registered for organized printing can be prevented.

When control part 10 detects that save button 439 in file listing screen 430 and “OK” button 448 in detail setting screen 440 has been clicked, page area changed or set and print setting information are stored in the individual print setting data 54 for each registered file name, in their respective screens (step S37). Subsequently, file name of files selected in the file selecting screen 420 are stored and updated in an order by their names, corresponding to the entire setting data 53 (step S39).

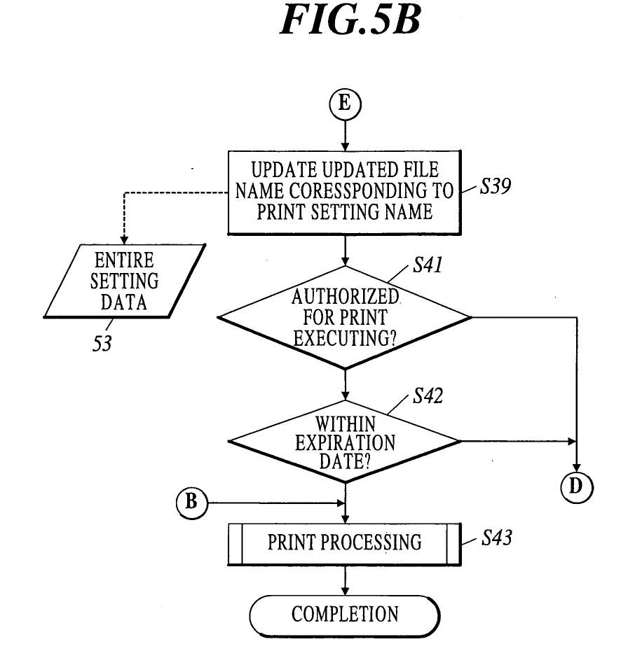

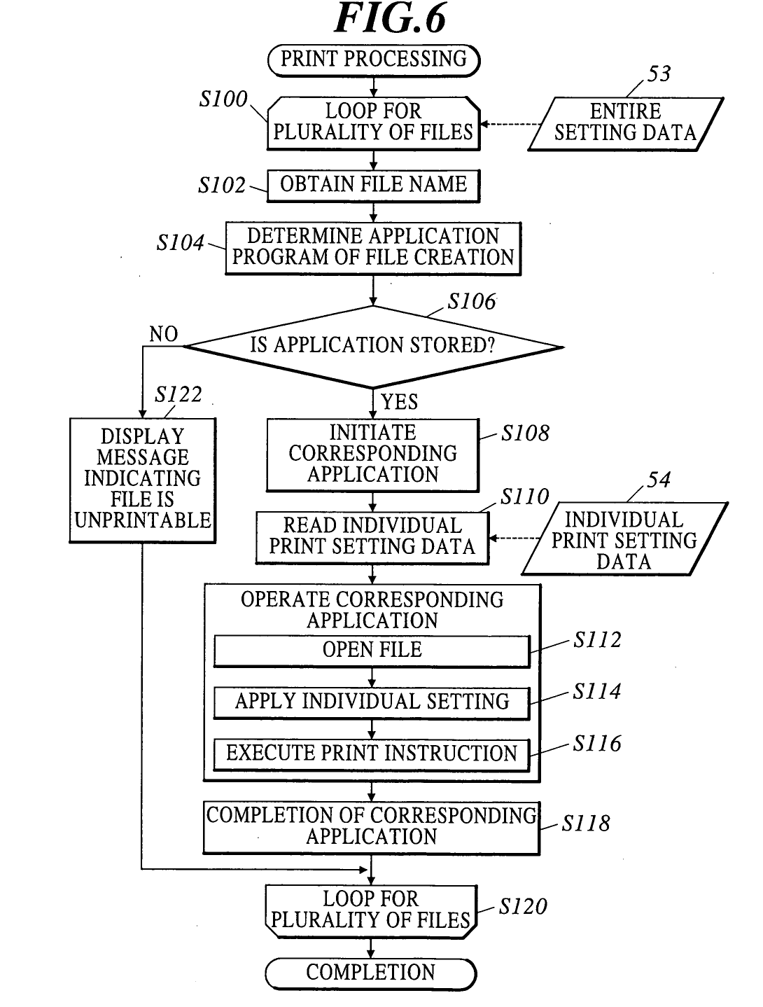

The control part 10 refers to the user management data 56, and in case availability of file operation corresponding to the inputted user ID is “authorized”, it is determined that the user has the authority of file operation (step S41; Yes). Further, in case present date and time is within an expiration date corresponding to the print setting name (step S42; Yes), it moves on to print processing (step S43) as shown in FIG. 6. In contrast, if it is determined that the user is not authorized (step S41; No), or the expiration date has expired (step S42; No), it moves on to processing of step S27 and displays detail setting screen 440.

In step S25, when it is detected that the save button 439 has been clicked (step S25; Save), processing moves on to step S37, and updates the individual print setting data 54 and the entire setting data 53.

In step S9, when it is detected that a print button 412 in the organized printing listing screen 410 has been clicked (step S9; Yes), the control part 10 refers to the user management data 56, and determines whether the user has the authority of print execution, in a similar way to step S41. When it is determined that the user has the authority of print execution (step S19; Yes), the control part 10 determines whether the present date and time is within the expiration date. When it is determined that it is within the expiration date, (step S21; Yes), the control part 10 moves on to print processing (step S43) as shown in FIG. 6, and starts printing each file.

When it is determined that the user does not have the authority of print execution (step S19; No), or that the present date and time is not within the expiration date (step S21; No), the control part 10 displays a message indicating that the selected print setting name cannot be performed organized printing is displayed in a window 416 as shown in FIG. 10A (step S23), and moves on to processing of step S7. In this way, print execution is allowed only to the user who has been authorized of print execution beforehand by the manager, and print execution is restricted to unauthorized user. Therefore, fraud print execution by a user other than the person in charge of the file for organized printing can be prevented.

When print processing is started in step S43, the control part 10 reads registered file name which corresponds to the print setting name selected by the user, from the entire setting data 53, and enters a loop (steps S100-S120) which performs sequential printing for each file of the registered file name.

First of all, registered file name corresponding to the print setting name selected by the user is obtained from the individual print setting data 54 (step S102), and application program of the file creation, according to the extension included in the registered file name is determined (step S204). Subsequently, determination is made on whether the application program is stored in the program memory part 40 (step S106), and when it is not stored (step S106; No), a message indicating that the file is unprintable is displayed on the user terminal 3 (step S122), and obtains next registered file name (step S102).

In step S106, when it is determined that application program is stored in the program memory part 40 (step S106; Yes), the control part 1o initiates the application program 41 (step S108), reads the page area and the print setting information corresponding to the obtained registered file name from the individual print setting data 54 (step S110).

Subsequently, by operating the application program 41, file of the registered file name is opened (step S112), read and applied the page area and print setting information in the individual print setting data 54, and then the applied file is outputted to a print instructing part 20 (step S114). The print instructing part 20 instructs print execution of the file, outputted from the control part 10, to the printing apparatus 5 through communication part 30 (step S116). The control part 10, after closing the initiated application program 41, obtains sequentially all of the registered file name corresponding to the print setting name, repeating the loop with steps S100-S120.

For example, as shown in FIG. 11, when A4 sized document file Fa, Fb, and Fc of “conference material 11/8.aaa”, “conference material 12/5.aaa”, and “conference material supplement.aaa” and A3 sized graph file Fd of “accompanying material.bbb” are performed organized printing, the user first makes selection by turning checkboxes for these files “ON” in the file selecting screen 420 as shown in FIG. 8A.

Subsequently, as shown in the file listing screen 430 of FIG. 8B, page area for each file is set, detail setting screen 440 is displayed by clicking detail setting button 436 for each file, and print setting information for each file is set. For example, list boxes LB4, LB5, and LB6 are each operated so as to keep file Fa set as default, perform consolidated printing of file Fb by two pages printed on one transfer paper, perform duplex printing of file Fc, and change paper size of file Fd to A4. At this time, by the control part 10, individual print setting data 54 is created with a data structure as shown in FIG. 2B.

When a print button 412 is clicked, print processing is performed according to this individual print setting data 54, and as shown in FIG. 11, print output for pages 3-7 of file Fa, consolidated printing for pages 2-10 of file Fb, duplex printing for pages 4-6 of file Fc, and reduced printing to A4 size for pages 9-20 of file Fd are sequentially performed. However, when file operation 453 is set in the manager screen 450 as shown in FIG. 9B, this organized printing can be performed only by “participant 1” and “participant 2”, not by “participant 3”. Additionally, edit operation of files Fa-Fd can be performed only by “participant 2” and “participant 3”.

Therefore, according to the present embodiment, since user usage of the file included in the print unit is restricted according to the usage setting information set for the print unit, security of a plurality of files created by application program can be improved. More particularly, by restricting user usage of file editing and print execution concerning a file additionally registered for organized printing, according to the usage restriction information stored for each user in user management data 56, only the authorized user can appropriately perform file editing and print execution in case of organized printing. Therefore, for example, since fraud file editing and fraud print execution by user without authority can be prevented, security in case of organized printing can be improved.

In case where a plurality of files created by user terminal 3 is stored in printer server 1, when these file are performed organized printing, instruction for print execution is performed for each file according to the individual print setting data 54, which stores page area and print setting information for each file. Therefore, since each file is managed at printer server 1 without converting the plurality of files into a data form specific to the printing apparatus 5, user can freely edit the file after organized printing.

In addition, since printing for each file is performed according to the individual print setting data 54, settings can be changed individually for each file based on scenes such as conference, presentation, or the like. The settings can also be changed freely after organized printing. Therefore, settings of a plurality of different files can be changed individually, and the user can perform editing or changing individual print settings without the burden of initiating corresponding application for each files. Accordingly, operability when performing print output for plurality of files can be improved.

Here, in the above-mentioned embodiment, user usage concerning operation of file editing and print execution was restricted. However, user usage such as file selection in file selecting screen 420, changing page area in file listing screen 430, changing print setting information in detail setting screen 440, and the like for example, can be restricted. In this case, within usage restriction information of the user management data 56, authority of selecting file, changing page area, and changing print setting information is stored associated with each user ID, and these availabilities are set by the manager. Accordingly, only in case when the user has the authority of selecting and changing, previously to step S37 and step S39, the entire setting data 53 and the individual print setting data 54 are updated. Preferably, in a similar way, user usage to access file selecting screen 420, file listing screen 430, and detail setting screen 440 is managed. The user's changing operation for print setting information can be restricted according to the availability of changing print setting information for the file included in the user restriction information. Accordingly, by managing usage restriction minutely, security in case of organized printing can be further enhanced.

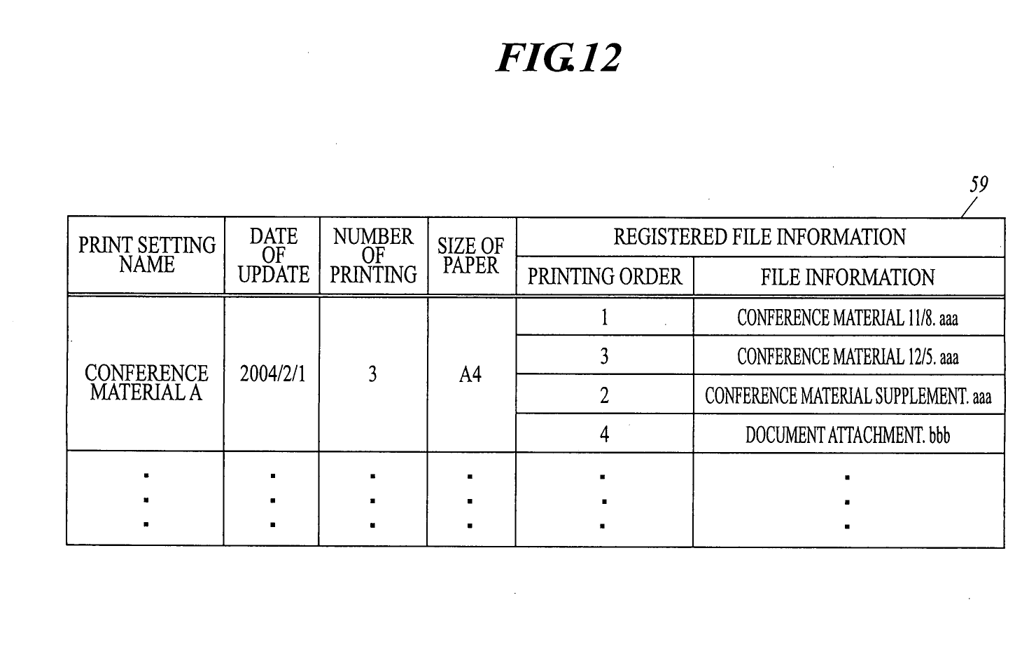

In addition, file names of the files selected by the user is stored in the entire setting data 53 and the individual print setting data 54, within an order (alphabetical order for example) stored in the file memory part 51, and performed print output in that order. However, the order for print output can be changeable and authority of changing this print order can be managed. In this case, data of entire setting data 59, which stores print order associated with each file name of registered file information, is structured as shown in FIG. 12. Meanwhile, within usage restriction information of the user management data 56, availability of selecting file, changing page area, and changing print setting information is stored associated with each user ID, and these availabilities are set by the manager.

Subsequently, only in case the user management data 56 is refereed, and the user has the authority of changing print order, for example, an order in which the user selected the file name is stored as the print order when storing file name in step S39. Accordingly, the user's changing operation of print order can be restricted according to the authority of changing print order of a file included in the usage restriction information, and print output of the file is performed in the order selected by the user, as well as changing the print order is performed only by the user who is authorized by the manager.

In addition, other than the printing schedule and expiration date, a starting date, which is the date when organized printing becomes available for print execution, can be managed. This can be achieved by storing the starting date associated with the print setting name of the user management data 56, and executing print processing when the present date and time has passed the starting date. Accordingly, since print output cannot be performed until the predetermined starting date, the file is managed in an electronic manner, and prevents the file from flowing by hard copy.

Additionally, printer server 1 was structured to be a different apparatus to the user terminal 3, however, function of printer server 1 may be incorporated into the user terminal 3, or may be incorporated into the printing apparatus 5, and the system structure of print managing system S can be modified arbitrarily.

The present application is based on Japanese Patent Application No. 2005-237375 filed with Japan Patent Office on Aug. 18, 2005.

What is claimed is:

1. A print management method comprising:
managing a plurality of files created by at least one application program as one print unit;
setting usage restriction information to the print unit; and
restricting a user usage of each file contained in the print unit according to the usage restriction information.

2. The print management method of claim 1, wherein the usage restriction information includes an advisability of editing the file contained in the print unit.

3. The print management method of claim 1, wherein the usage restriction information includes an advisability of printing the file contained in the print unit.

4. The print management method of claim 1, wherein the usage restriction information includes an advisability of changing print setting information of the file contained in the print unit.

5. The print management method of claim 1, wherein the usage restriction information includes an advisability of changing a print order of the file contained in the print unit.

6. The print management method of claim 1, wherein the usage restriction information for each of the print unit is set for each user.

7. A recording medium which stores a program, the program having a computer execute:
a management function to manage a plurality of files created by at least one application program as one print unit;
a setting function to set usage restriction information to the print unit; and
a restriction function to restrict a user usage of each file contained in the print unit according to the usage restriction information.

8. The recording medium of claim 7, wherein the usage restriction information includes an advisability of editing the file contained in the print unit.

9. The recording medium of claim 7, wherein the usage restriction information includes an advisability of printing the file contained in the print unit.

10. The recording medium of claim 7, wherein the usage restriction information includes an advisability of changing print setting information of the file contained in the print unit.

11. The recording medium of claim 7, wherein the usage restriction information includes an advisability of changing print setting information of the file contained in the print unit.

12. The recording medium of claim 7, wherein the setting function sets the usage restriction information for each of the print unit for each user.

13. A print management apparatus comprising:
a first memory part to store a plurality of files created by at least one application program as one print unit;
a second memory part to store usage restriction information for the print unit; and
a usage restriction part to restrict a user usage of each file contained in the print unit according to the usage restriction information.

14. The print management apparatus of claim 13, wherein the usage restriction information includes an advisability of editing the file contained in the print unit.

15. The print management apparatus of claim 13, wherein the usage restriction information includes an advisability of printing the file contained in the print unit.

16. The print management apparatus of claim 13, wherein the usage restriction information includes an advisability of changing print setting information of the file contained in the print unit.

17. The print management apparatus of claim 13, wherein the usage restriction information includes an advisability of changing a print order of the file contained in the print unit.

18. The print management apparatus of claim 13, wherein the second memory part stores the usage restriction information for each of the print unit for each user.
